(19) United States
(12) Patent Application Publication
(10) Pub. No.: US 2004/0123142 A1
(43) Pub. Date: Jun. 24, 2004

(54) Detecting a network attack

(76) Inventors: Scott P. Dubal, Hillsboro, OR (US); Douglas D. Boom, Portland, OR (US); Patrick L. Connor, Portland, OR (US); Mark V. Montecalvo, Hillsboro, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/323,985

(22) Filed: Dec. 18, 2002

(51) Int. Cl. H04L 9/00

(52) U.S. Cl. 713/201

(57) ABSTRACT

In general, in one aspect, the disclosure describes techniques of detecting a network attack. The method includes receiving at least one packet at a device; and determining whether the at least one received packet has at least one characteristic of a denial of service attack. Based on the determining, the packet may not be processed by a transport layer protocol.

### BACKGROUND

Communicating over a network involves a wide variety of tasks. Typically, these tasks are grouped into different layers of network operations. Briefly, the lowest layer, known as the physical layer, handles, among other things, tasks involved in the reception of signals over a connection and the translation of these signals into digital bits (e.g., 1-s and 0-s). Above the physical layer, the “link layer” can group the bits into a logical organization known as a frame. A frame often includes flags (e.g., start and end of frame flags), a frame checksum that enables a receiver to determine whether transmission errors occurred, and so forth

A frame may also store one or more packets. By analogy, a packet is much like a mailed letter. That is, the letter being mailed is like a packet's payload while the mailing and return addresses are like source and destination addresses stored in a packet's header. The “network layer” can use data in a packet's header to find a route through a network that connects a sender and receiver. Since a message may be spread across many different packets that independently travel across a network, the “transport layer” can reorder and reassemble transmitted data into its original form.

Together, the different layers form a “protocol stack”. A device may select from a wide variety of protocols operating in the different stack layers. For example, many computers on the Internet use a stack known as the Transport Control Protocol/Internet Protocol (TCP/IP) protocol stack that features TCP as the transport layer protocol and IP as the network layer protocol.

To connect to a network, devices often use a network adapter. A network adapter often includes physical layer and link layer components. In many systems, network operations are divided between the adapter and host. For example, in many systems, when the adapter identifies a received packet, the adapter transfers the packet to a host (e.g., memory of a personal computer) and alerts the host to the packet's arrival. The host often includes software to continue processing the packet in accordance with network and transport layer protocols.

### BRIEF DESCRIPTION OF THE DRAWINGS

FIG. 1 is a diagram of a device to detect denial of service attacks.

FIGS. 2-4 are flowcharts of processes for detecting denial of service attacks.

FIGS. 5-6 are diagrams illustrating operation of a remote server notified of attacks.

FIG. 7 is a flowchart illustrating operation of the remote server.

FIG. 8 is a diagram of a network adapter including logic for detecting denial of service attacks.

### DETAILED DESCRIPTION

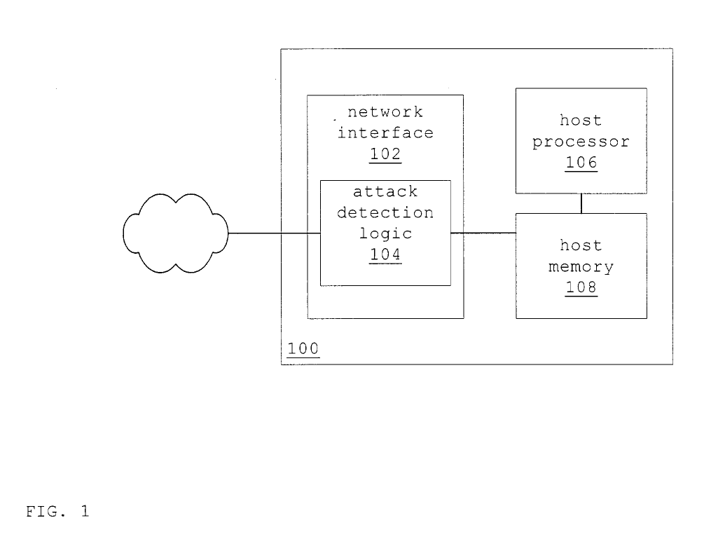

Network devices may be subjected to a variety of attacks that attempt to disrupt normal network operation. For example, denial of service (DoS) attacks attempt to reduce a network's ability to process valid network traffic by introducing “forged” network traffic. These forged packets have a variety of different tell-tale characteristics. For example, some attacks include erroneous source addresses chosen to cause predictable, though unfortunate, responses by a receiver. FIG. 1 depicts a system 100 that can detect and, potentially, thwart such attacks. The system 100 may be, for example, a configured personal computer (PC), laptop computer, network switch or router, wireless device, or network appliance. The system 100 shown connects to a network via a network adapter 102 (e.g., a network interface card (NIC)) that includes logic 104 to detect and, potentially, react to network attacks. In addition to detecting attacks, the adapter 102 can potentially conserve host resources 106, 108 by halting processing of the packet before the packet is processed by the network and/or transport layers of the protocol stack.

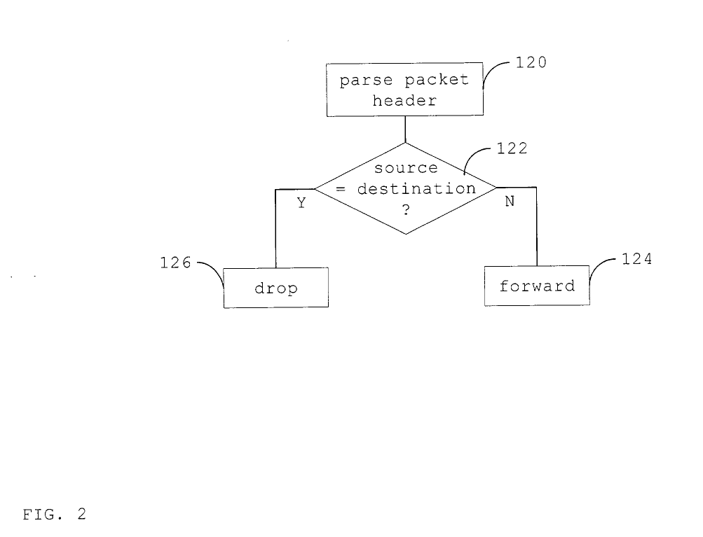

To illustrate examples of logic 104 operation, FIGS. 2-4 depict techniques for detecting a variety of denial of service attacks based on characteristics of packets involved in such attacks.

FIG. 2 illustrates logic that the network adapter 102 can use to detect a LAND denial of service attack. Briefly, a LAND attack involves sending a packet to a destination with a “spoofed” source IP address that is set to the destination's IP address instead of the address of the actual packet source (i.e., the attacker's node). By analogy, this is much like sending a letter having the same return address as the addressee. The packet is also constructed to elicit a response from the receiver. For example, a LAND attack may take the form of a TCP/IP SYN packet. In TCP, when a receiver receives a SYN packet the receiver typically acknowledges its receipt. However, in the receiver's attempt to acknowledge the spoofed packet, the receiver attempts to send a message to itself. This may cause the receiver to loop indefinitely, flood itself with messages consuming memory and/or processor cycles and/or other resources, and/or otherwise crash.

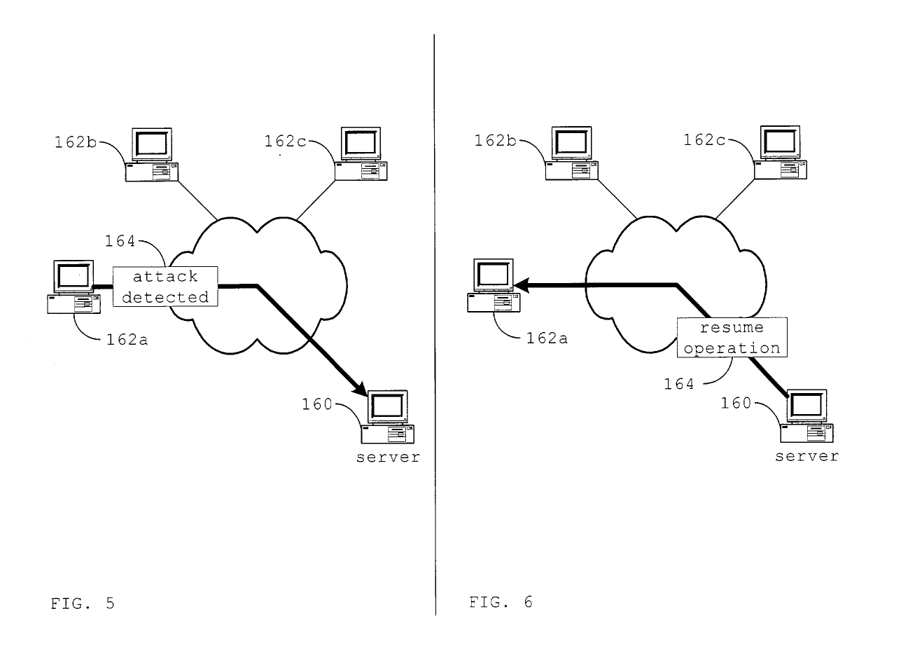

To prevent a packet of a LAND attack from reaching the network (e.g., IPv4 or IPv6) and/or transport layers (e.g., TCP, User Datagram Protocol (UDP), Real-Time Transport Protocol (RTP)) of a protocol stack, the logic can parse 120 data within the packet and determine whether the packet has a source address that matches the address of the device. For example, the process can compare 122 the source and destination IP or Ethernet addresses of the packet. If equal, the packet may be dropped 126 and/or result in other responses by the logic 104 (e.g., incrementing an on-board attack counter, cause entry in a log, notification of the attack to a remote server (see FIGS. 5-7), and so forth). Packets not having this characteristic of a LAND attack may be forwarded 124 for further processing, for example, by network and transport layer protocols of the protocol stack (e.g., ACK generation and traversal of a TCP finite state machine).

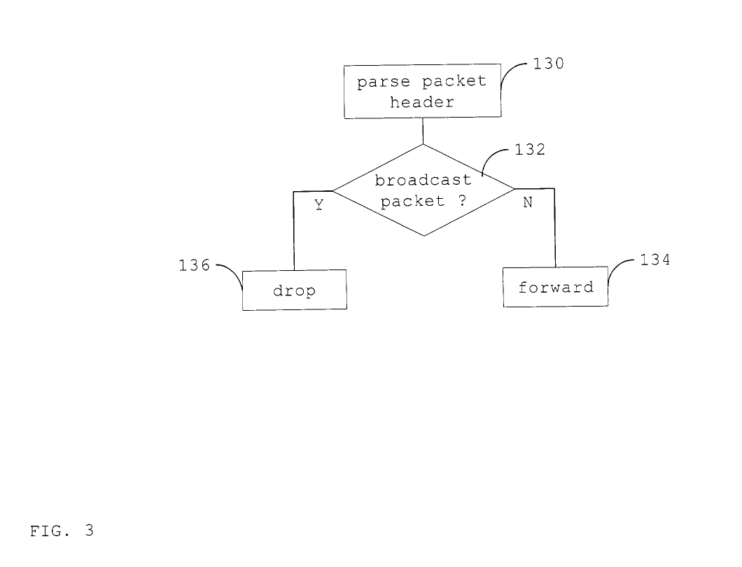

As another example, as shown in FIG. 3, the logic 104 may also attempt to identify “SMURF” denial of service attacks. Briefly, a SMURF attack typically involves three entities: an attacker, one or more intermediaries, and a victim. The attacker sends the intermediaries a message with a forged source address of the victim. The message is chosen to elicit a response from the intermediate receivers. For example, a SMURF attack packet may include an Internet Control Message Protocol (ICMP) echo request such as a Packet Internet Groper (PING) command. Such a message causes the intermediaries to respond by sending replies to the victim instead of the actual packet source (the attacker). The victim can quickly become overwhelmed with traffic sent by the unsuspecting intermediaries. To aggregate a large number of intermediaries, a SMURF attacker can send a packet using a broadcast destination address (e.g., an IP address of a sub-net followed by 1-s). This can cause a copy of the packet to be sent to each device on a sub-net. Thus, a single message from the attacker can cause a message to be sent to the victim from each device on a sub-net, amplifying the attack. To generate a very large number of messages, the attacker may continually send such broadcast packets to the sub-net.

To, at least partially, undermine a SMURF attack, the logic 104 may implement the process shown in FIG. 3. As shown, after parsing 130 a packet, the process determines 132 if the packet has a broadcast destination address. If so, the process can drop 136 the packet to avoid participation in a SMURF attack as an intermediate. Again, such a process may perform other operations in response to detecting this characteristic of a SMURF attack. For packets not having this characteristic, the process can forward 134 the packet for further processing, for example, by the network and/or transport layers.

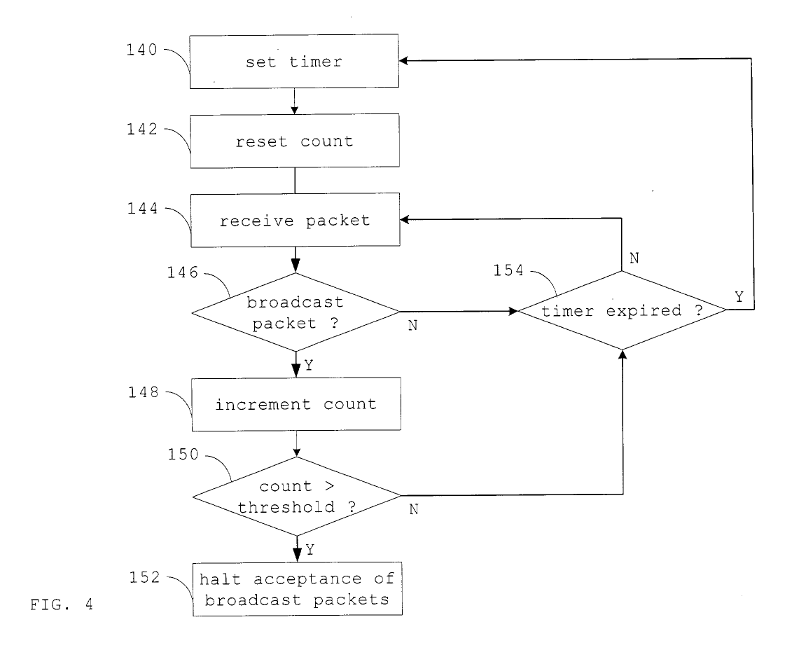

Unfortunately, in addition to SMURF attacks, the process shown in FIG. 3 may also filter out legitimate broadcast packets. To increase the likelihood the logic 104 is responding to an attack instead of legitimate traffic, FIG. 4 depicts a process that permits acceptance of broadcast packets provided a limited number of such packets are received within a window of time. For example, as shown, after a timer 140 and a count 142 of the number of received broadcast packets are reset, the process increments the count 148 for each broadcast packet received 146. If the count of broadcast packets exceeds 150 a threshold, the process can halt acceptance 152 of further broadcast packets for some period of time or until an external agent lifts the broadcast packet restriction.

The timer and threshold setting may be pre-configured or may be dynamically determined. For example, the process may decrease the threshold and/or timer setting based on a frequency of detected attacks. If the timer expires 154 before the broadcast packet count exceeds the threshold, the timer and count are again reset 140, 142.

While FIGS. 2 to 4 illustrate logic to combat LAND and SMURF attacks, similar techniques can detect other attacks. For example, other denial of service attacks feature broadcast source addresses. Additionally, while the example attacks described above were described in conjunction with Internet Protocol addresses, similar techniques may be used to detect attacks within other protocols such as Ethernet and a variety of multicasting protocols.

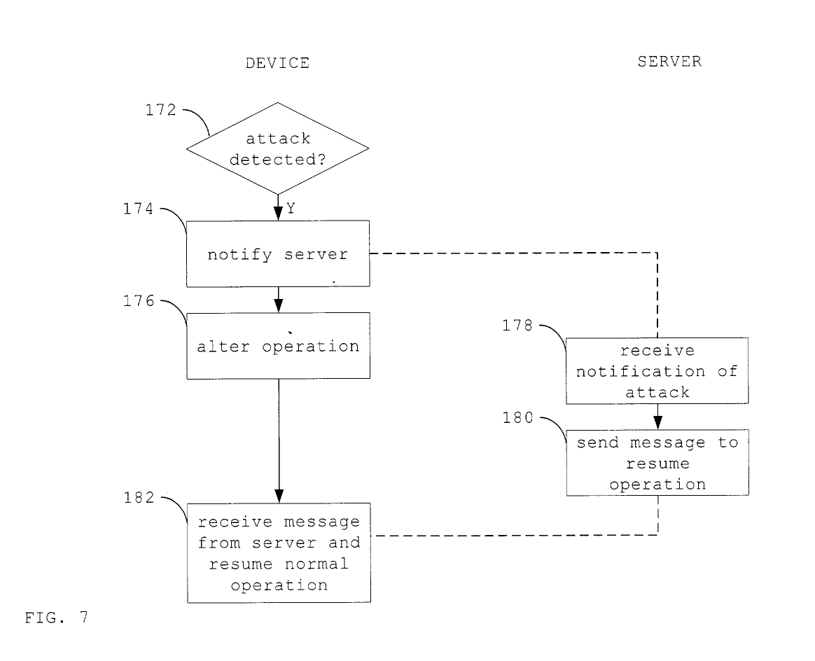

As described above, the network adapter logic 104 may detect a variety of network attacks. In addition, or as an alternative, to merely dropping the packets forming the suspected attack, the adapter may take additional or alternative counter-measures. For example, FIG. 5 depicts a remote server 160 that can receive notification 164 of attacks detected by different network adapters. The remote server 160 can, potentially, coordinate a response to the attacks. For example, after receiving notification of a SMURF attack detected in one sub-net, the server can preemptively set network adapters in other server 160 managed sub-nets to handle broadcast packets more restrictively (e.g., using the logic of FIG. 3 instead of the logic of FIG. 4). As shown in FIG. 6, the server 160 can subsequently instruct a device to restore normal packet processing.

In greater detail, as shown in FIG. 5, a device 162a can notify a server 160 of a detected attack. For example, the device 162a may send the server 160 a Remote Management Control Protocol (RMCP) formatted message used by Alert Standard Forum (ASF) enabled devices (see, e.g., Alert Standard Forum Specification, version 1.0, Jan. 17, 2001). Briefly, ASF enabled devices send RMCP messages to notify servers of a variety of system events and/or status (e.g., overheating, cover removed, and so forth). The ASF specification includes different handshake mechanisms to ensure reliable server/client communication. Additionally, the ASF scheme permits extensions to its basic set of messages. Thus, to report network attacks, a RMCP message class may be defined for network attacks with various message types defined for different types of network attacks.

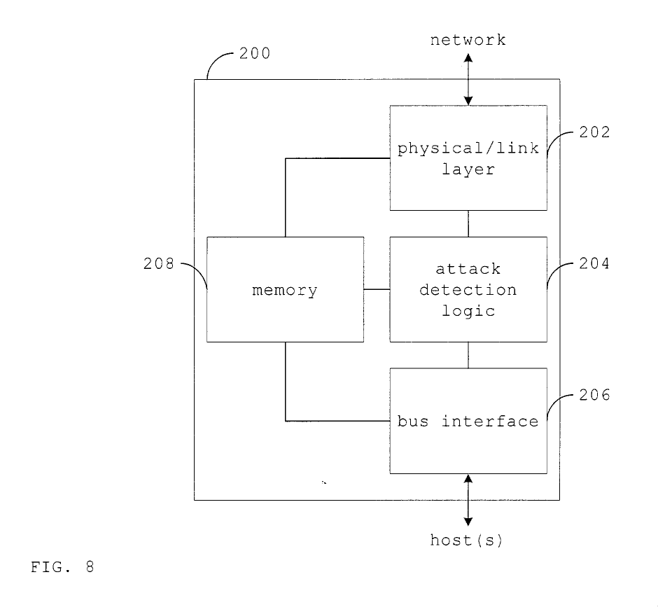

FIG. 7 illustrates an example of interaction between the remote server and a device detecting an attack. As shown, after detecting 172 an attack, the device notifies 174 the remote server of the attack. Potentially, the device may re-transmit such a message if the device does not receive acknowledgement of the message within some period of time. If so configured, the device may alter 176 its operation in response to the attack. For example, the device may drop all subsequently received packets other than RMCP messages sent by the server.

After receiving 178 notification of the attack, the server can acknowledge the notification (not shown). The server may respond to the message in a variety of ways. For example, when one device detects a LAND attack, the server can anticipate attacks on other devices and remotely reconfigure devices not yet attacked. At a later time, the server can send 180 a message to the device to restore 182 operation.

FIG. 8 is a diagram of a network adapter 200 including attack detection logic 204. As shown, the network adapter 200 includes a link layer component (e.g., an Ethernet medium access controller (MAC) or Synchronous Optical Network (SONET) framer) 202. The adapter 200 may also include a physical layer (PHY) component to handle data transmission/reception over a physical medium (e.g., copper wire, twisted wire pair cabling, coaxial cabling, fiber optic cabling, or wireless medium). The adapter 200 shown also includes a bus interface 206. The interface 206 can transfer packet data to host memory, for example, using direct memory access (DMA) and generate an interrupt to the host processor when packet transfer is complete. The bus interface 206, for example, can interface to a Peripheral Component Interconnect (PCI) bus (e.g., PCI express), Universal Serial Bus (USB), or InfiniBand bus, among others.

As shown, the adapter 200 also features memory 208 to store packets as they arrive via the PHY/link layer components 202. The attack detection logic 204 can operate on the packets as they arrive in memory. By detecting attacking packets, the adapter 200 can not only prevent behavior sought by the attack, but can also potentially conserve host memory and processing resources by stopping packet processing before transfer of the packet to the host.

The logic 204 may be implemented in a wide variety of ways. For example, the logic 204 may be implemented as hardware (e.g., an integrated circuit chip, Programmable Gate Array (PGA), Application Specific Integrated Circuit (ASIC), or a micro-controller). The logic 204 may also be implemented as software instructions for execution by an adapter 200 processor. Such instructions may be disposed on a computer readable medium such as a magnetic (e.g., hard disk, floppy disk, tape) or optical storage medium (e.g., CD ROM, DVD ROM) or other volatile or non-volatile memory device(s) (e.g., EEPROM, ROM, PROM, RAM, DRAM, SRAM, flash, firmware, etc.).

The adapter 200 may include other components. For example, the adapter may include other packet filters and/or a TCP Offload Engine (TOE) that performs TCP protocol operations on packets after their examination by the attack detection logic 204. A TOE can further reduce the burden of network operations on a host processor. Additionally, the attacks detected and the adapter's responses may be configured, for example, by setting dip switches, jumpers, via EEPROM, host software, or other mechanisms.

Other implementations are within the scope of the following claims. For example, while discussed in terms of a TCP/IP protocol stack, the detection logic may be used in other environments (e.g., a Asynchronous Transfer Mode (ATM) protocol stack that features an ATM network layer and an ATM Adaptation Layer (AAL) transport layer. In addition to a network interface card, the network adapter may be included within other hardware (e.g., a chipset, motherboard, or PCI slot).

What is claimed is:

1. A method of detecting a network attack, comprising:
receiving at least one packet at a device;
determining whether the at least one received packet has at least one characteristic of a denial of service attack; and
if it is determined that the at least one received packet has at least one characteristic of a denial of service attack, preventing processing of the at least one received packet by a transport layer protocol of a protocol stack.

2. The method of claim 1, wherein if it is determined that the at least one received packet has at least one characteristic of a denial of service attack, preventing processing of the at least one received packet by a network layer protocol of the protocol stack.

3. The method of claim 1, wherein the at least one characteristic comprises a characteristic of at least one of the following: a source address of the packet and a destination address of the packet.

4. The method of claim 1, wherein the determining whether the packet has at least one characteristic of a denial of service attack comprises determining if the packet has a source address that matches an address of the device.

5. The method of claim 4, wherein the determining whether the packet has a source address that matches the network address of the device comprises determining whether the packet has the same source and destination addresses.

6. The method of claim 1, wherein the determining whether the packet has at least one characteristic of a denial of service attack comprises determining if the packet includes a broadcast address.

7. The method of claim 6, wherein the determining further comprises determining whether the packet comprises an Internet Control Message Protocol (ICMP) Packet Internet Groper (PING) message.

8. The method of claim 6, further comprising determining whether a count of broadcast packets received exceeds a threshold.

9. The method of claim 8, further comprising resetting the count after a time period elapses.

10. The method of claim 1, further comprising dropping packets based on the determining.

11. The method of claim 10, further comprising processing packets in accordance with a network layer protocol after determining that the packet did not have at least one characteristic of a denial of service attack.

12. The method of claim 10, further comprising processing packets in accordance with the transport layer protocol after determining that the packet did not have at least one characteristic of a denial of service attack.

13. The method of claim 1, further comprising notifying a remote server of a detected attack.

14. The method of claim 13, further comprising:
altering at least one packet processing operation of the device after detecting the attack; and
receiving a message from the remote server to restore the at least one packet processing operation.

15. A network adapter, the adapter comprising:
at least one link layer component to receive bits generated by at least one physical layer component (PHY);
a bus interface to communicate with a host; and
logic to operate on packets received via the at least one link layer component, the logic to:
receive at least one packet at a device;
determine whether the at least one received packet has at least one characteristic of a denial of service attack; and
if it is determined that the at least one received packet has at least one characteristic of a denial of service attack, prevent processing of the at least one received packet by a transport layer protocol of a protocol stack.

16. The adapter of claim 15, wherein the logic comprises logic to, if it is determined that the at least one received packet has at least one characteristic of a denial of service attack, prevent processing of the at least one received packet by a network layer protocol of a protocol stack.

17. The adapter of claim 15, wherein the at least one characteristic comprises a characteristic of at least one of the following: a source address of the packet and a destination address of the packet.

18. The adapter of claim 15, wherein the logic to determine whether the packet has at least one characteristic of a denial of service attack comprises logic to determine if the packet has a source address that matches an address of the device.

19. The adapter of claim 18, wherein the logic to determine whether the packet has a source address that matches the network address of the device comprises logic to determine whether the packet has the same source and destination addresses.

20. The adapter of claim 15, wherein the logic to determine whether the packet has at least one characteristic of a denial of service attack comprises logic to determine if the packet includes a broadcast address.

21. The adapter of claim 20, wherein the logic to determine further comprises logic to determine whether the packet comprises an Internet Control Message Protocol (ICMP) Packet Internet Groper (PING) message.

22. The adapter of claim 20, further comprising logic to determine whether a count of broadcast packets received exceeds a threshold.

23. The adapter of claim 22, further comprising logic to reset the count after a time period elapses.

24. The adapter of claim 15, further comprising logic to drop a packet if the packet has at least one characteristic of a denial of service attack.

25. The adapter of claim 15, further comprising logic to notify a remote server of a detected attack.

26. The adapter of claim 25, further comprising logic to:
alter at least one packet processing operation of the device after detecting the attack; and
receive a message from the remote server to restore the at least one packet processing operation.

27. The adapter of claim 25, wherein the logic comprises a processor and instructions on a processor readable medium.

28. The adapter of claim 25, wherein the bus interface comprises an interface to at least one of the following: a Peripheral Component Interconnect (PCI) bus, Universal Serial Bus (USB), or InfiniBand bus.

29. The adapter of claim 25, further comprising at least one physical layer component.

30. A system comprising:
at least one host processor;
memory accessible by the at least one host processor;
at least one network adapter, comprising:
at least one physical layer (PHY) component;
at least one link layer component coupled to the at least one PHY component;
a bus interface to communicate with the at least one host processor; and
logic to operate on packets received via the link layer component, the logic to:
receive at least one packet at a device;
determine whether the at least one received packet has at least one characteristic of a denial of service attack; and
if it is determined that the at least one received packet has at least one characteristic of a denial of service attack, prevent processing of the at least one received packet by a transport layer protocol of a protocol stack

31. The system of claim 30, wherein the logic comprises logic to, if it is determined that the at least one received packet has at least one characteristic of a denial of service attack, prevent processing of the at least one received packet by a network layer protocol of a protocol stack.

32. The system of claim 30, wherein the logic to determine whether the packet has at least one characteristic of a denial of service attack comprises logic to determine if the packet has a source address that matches the address of the device.

33. The system of claim 30, wherein the logic to determine whether the packet has at least one characteristic of a denial of service attack comprises logic to determine if the packet includes a broadcast address.

34. The system of claim 33, further comprising logic to determine whether a count of broadcast packets received exceeds a threshold.

35. The system of claim 30, further comprising logic to drop packets if the packet has at least one characteristic of a denial of service attack.

36. The system of claim 30, further comprising logic to notify a remote server of a detected attack.

37. A system comprising:
at least one host processor to process packets in accordance with Internet Protocol (IP) and Transport Control Protocol (TCP) protocols;
memory accessible by the at least one host processor;
at least one network adapter, comprising:
at least one physical layer (PHY) component;
at least one Ethernet medium access controller (MAC) coupled to the at least one PHY component;
a bus interface to communicate with the at least one host processor accessible memory via Direct Memory Access (DMA); and
logic to operate on packets received via the Ethernet MAC, the logic to:
receive at least one packet; and
determine whether the at least one received packet has at least one characteristic of a denial of service attack; and
if it is determined that the at least one received packet has at least one characteristic of a denial of service attack, prevent processing of the at least one received packet by the host Internet Protocol and Transport Control Protocol protocols.

38. The system of claim 37, wherein the logic further comprises logic to transmit an Alert Standard Forum (ASF) Remote Management Control Protocol (RMCP) message to a remote server if it is determined that denial of service attack is occurring, the message identifying the type of denial of service attack.
